(19) United States
(12) Patent Application Publication
(10) Pub. No.: US 2004/0104318 A1
(43) Pub. Date: Jun. 3, 2004

(54) Constructive arrangement introduced in a wall support for television set and other appliances

(76) Inventor: Gilberto Goncalves Oliveira Filho, Sao Paulo (BR)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 10/630,295

(22) Filed: Jul. 30, 2003

(30) Foreign Application Priority Data
Dec. 3, 2002 (BR) MU 8202789-7

(51) Int. Cl. F16L 3/00

(52) U.S. Cl. 248/121

(57) ABSTRACT

A constructive arrangement introduced in a wall support for television set and other appliances, as indicated by numerical reference (1), characterized for having a horizontal tubular arm (2), an intermediate structure (3), containing a handle (3a), two tubular structures (4), tubular sectors (5), fitting parts (6), two blades (4a), lateral structures (7), vertical supports (8), with top ends (8a) having plastic tips (8b), bottom support (9) with lateral ends (9a), AL-profiled supports (10), with upper portion with semicircular profiles (10a), handles (11), fixation base (12).

The present report refers to a Utility Model Patent treating of a new constructive arrangement introduced in a wall support for television set and other appliances, characterized for having in its structure constructive elements providing a safe support for television sets, video-cassette recorders, DVD devices, etc.

As it is generally known, installation of television set and other appliances in residences, offices, commercial establishments, consultation rooms and other places, requires a means to support them in certain place and a suitable position. However, most times bookcases and tables are used in dimensions which may be higher than those required to accommodate such appliances, and so they occupy space in the environment other than that as previously provided.

Another possible arrangement for above-described devices is by using wall supports, however most current models have a constructivity which presents a certain degree of complexity both in its assembly and handling, which to some extent implies in higher efforts to use them on the part of the user.

In view of above-mentioned shortcomings, a wall support for television set and other appliances has been designed by the applicant of the present application for Utility Model Patent.

In view of above-exposed concept, a constructive arrangement inserted in a wall support for television set and other appliances has been developed, characterized in that its general structure has elements which facilitate the installation of television sets and other appliances.

Thus, an object of the present Utility Model patent is to provide a constructivity which may be implemented in a wall support for television set and other appliances which, in function of the novelty now proposed, begins to be provided with lateral structures, which have two front support arms, thereby providing a safer and quick means to accommodate television sets and other appliances.

The use of such lateral structures provides the relevant support with a great increment in its manufacture, on view of the reduction in the number of components to meet the same function, thereby providing an optimization in production means, reducing the time of its manufacture and a consequent reduction in costs, the use of said lateral structures being a characteristic which is not provided in the technique.

Thus, the object of the present Utility Model patent is to propose a constructivity introduced in a wall support, which presents positive aspects as it has in its general structure some elements which provide safety and speed as to installation of television sets and other appliances.

Due to characteristics pertaining to above-mentioned technique and in view of the objectives proposed, the present constructive arrangement introduced in a wall support has been developed, which will be described in detail with reference to drawings listed below, in which:

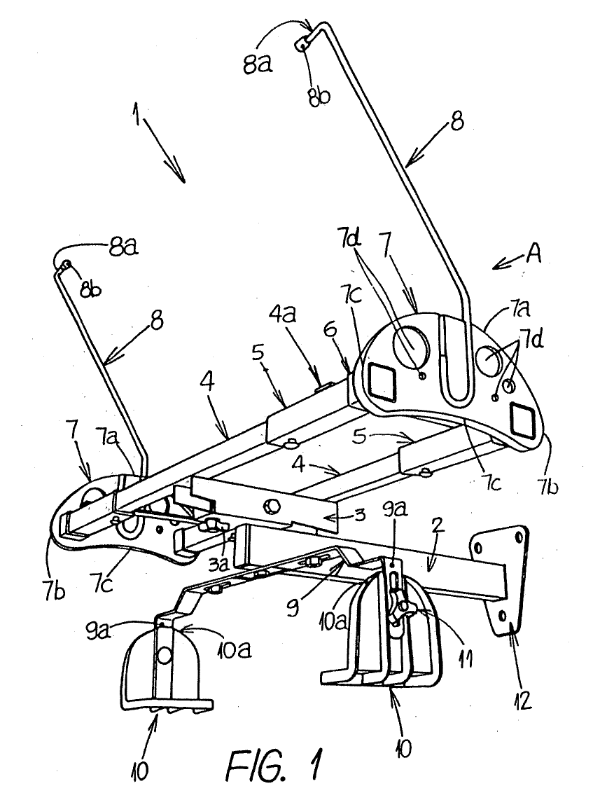

FIG. 1 is a perspective view of the first support model;

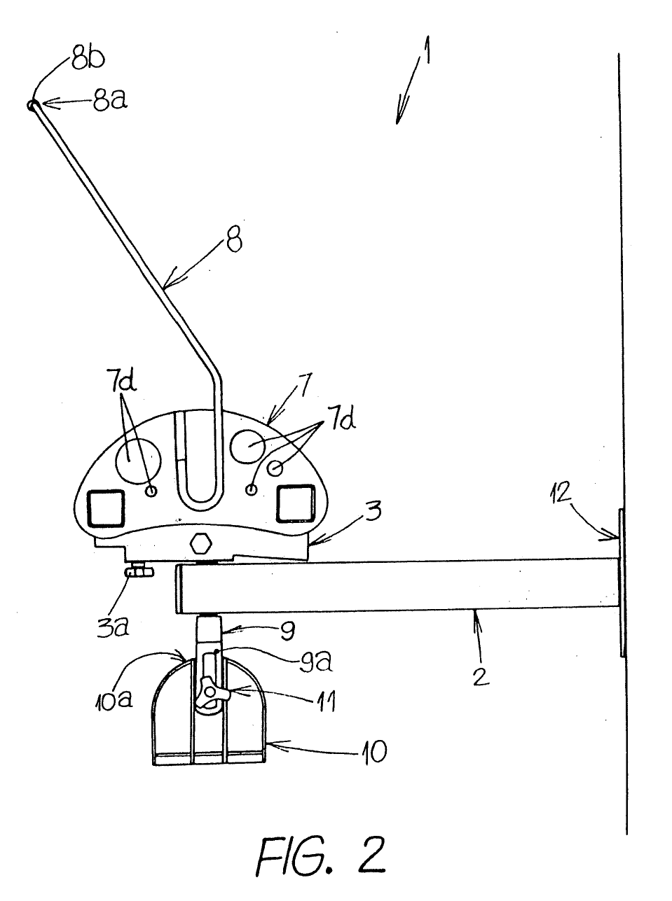

FIG. 2 is a side view of the first model of FIG. 1, as indicated by arrow A;

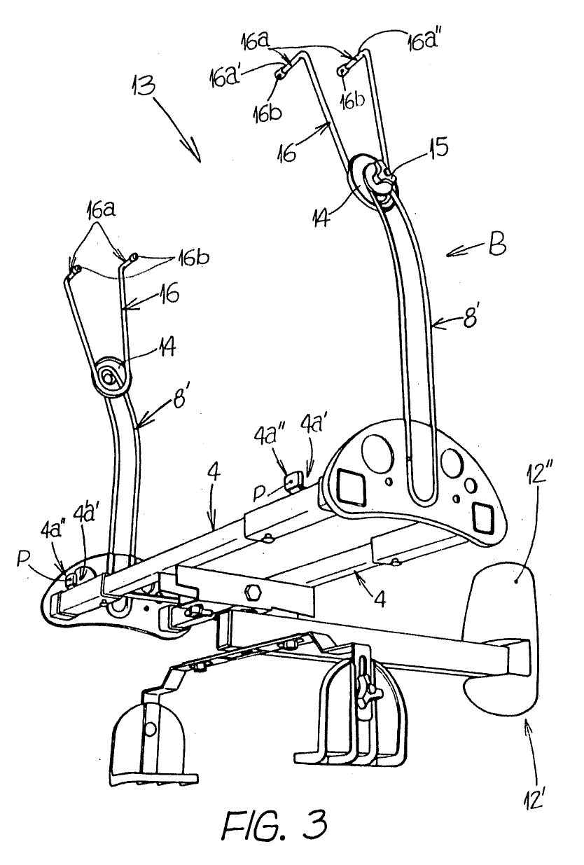

FIG. 3 is a perspective view of a variant of the first support model of FIG. 1; and

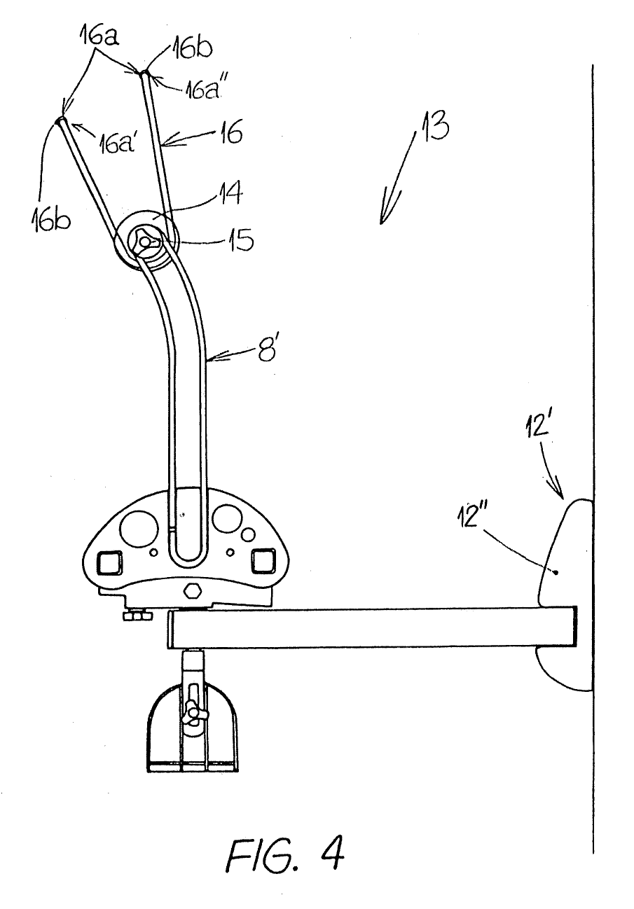

FIG. 4 is a side view of the variant of FIG. 3, as indicated by arrow B.

According to above-listed figures, the support treated in the present application for Utility Model patent comprises a first model and a variant of this first model.

According to FIGS. 1 and 2, the constructive arrangement introduced in a wall support, which is object of this Utility Model patent, and indicated by the numerical reference 1, is characterized in that it has a horizontal tubular arm 2, of rectangular section, in whose frontal end an intermediate structure 3 is fastened, from the top, through a bolt, which tubular structure contains a handle 3a over which two tubular structures of the same length 4 are fastened in parallel and perpendicularly, having tubular sectors 5 in their ends, incorporating fitting parts 6.

Over the two tubular structures 4, two blades 4a are fastened, which provide a better stability to the assembly of the two tubular structures 4, with tubular sectors 5 and fitting parts 6, in addition to providing a more effective support for devices placed on said structures.

Connected with the ends of tubular structures 4, through tubular sectors 5 and fitting parts 6, there are lateral structures 7, whose profile presents a semicircular shaping 7a in their upper portion, as well as lateral arcs 7b and a bottom arc 7c. Circular openings 7d, of different diameters, are distributed along the lateral structure surfaces 7,

Fastened to outside faces of lateral structures 7, vertical supports 8 are mounted, which protrudes ahead, whose top ends 8a are bent in right angle, turned inwards the relevant support. Plastic tips 8b provide finishment to final portions of top ends 8a.

These vertical support 8 provide a safe installation of devices to be mounted over said wall support, whose top ends 8a are positioned so as to establish a more approached contact with frontal areas of devices to be installed, in order to hold them fastened in their positions.

Beneath the horizontal tubular arm 2, there is a bottom support 9a, having in the internal part of its lateral ends 9a, L-profiled supports 10, whose upper portions present semicircular profiles 10a.

L-profiled supports 10 are fastened to lateral ends 9a of the bottom support 9, through handles 11.

At the back end of horizontal tubular arm 2, a fixation base 12 is fastened, which has holes thorough which the bolts used to fasten the support to the wall will pass.

As to FIGS. 3 and 4, it is possible to check that the present support is a variant of the first model of support, which is indicated by the numerical reference 13, characterized in that it has essentially the same constructive elements as the first model of support indicated by reference 1, this variant being indicated by reference 13, has as differentiated elements regarding the first model, vertical supports 8′, which in turn have a disc 14 in each of their top ends, which incorporates a handle 15, in which a forked structure 16 is fastened, whose upper ends 16a, are bent in right angle, turned inwards the relevant support. Those ends 16a provide a better stability at the time of installation of the equipment to be placed in said support, since sector 16a=of end 16a, touches the frontal face of the device to be installed, while sector 16a′, also of end 16a, touches the top face of said device. Plastic tips 16b provide finishing to final portions of top ends 16a.

Other elements different from the first models are the blades 4a′, which are assembled on the two tubular structures 4, whose frontal ends are bent upwards, in right angle, thereby forming stretches 4a″, covered with a plastic cover P, thereby providing an additional reinforcement, when stretches 4a″ contact the bottom portion of the device to be installed in said wall support.

A protection cover 12′ covering the fixation base 12′ of said variant completes the series of improvements performed in this variant, indicated by the numerical reference 13, thereby giving to the present support an aesthetic appearance which results in an excellent visual balance.

What is claimed is:

1. A constructive arrangement introduced in a wall support for television set and other appliances, of the type specially intended to serve as a support for televisions sets, video-cassette recorders, DVD devices, etc, and which is indicated by the numerical reference (1), said support being characterized for comprising a horizontal tubular arm (2), of rectangular section, in whose frontal end is fastened, from the top, through a bolt, an intermediate structure (3), containing a handle (3a), on which two tubular structures (4) of the same length are fastened in parallel and perpendicularly, having tubular sectors (5) in its ends, incorporating fitting parts (6); over the two tubular structures (4), two blades 4a are fastened.

2. A constructive arrangement introduced in a wall support for television set and other appliances according to claim 1, characterized in that the lateral structures (7) are connected to the tubular structure ends (4), through tubular sectors (5) and fitting parts (6).

3. A constructive arrangement introduced in a wall support for television set and other appliances, according to claim 2, characterized in that each lateral structure (7) presents a semicircular shaping profile (7a) in its top position, as well as lateral arcs (7b) and a bottom arc (7c); circular openings (7d) of different diameters, are distributed in the lateral structure (7) surfaces.

4. A constructive arrangement introduced in a wall support for television set and other appliances, according to claim 2, characterized in that vertical supports (8) fastened to lateral structures (7) are mounted, protruding ahead, whose top ends (8a) are bent in right angle, turned inwards of the relevant support; plastic tips (8b) provide finishment to final parts of top ends (8a).

5. A constructive arrangement introduced in a wall support for television set and other appliances, according to claim 1, characterized in that beneath the horizontal tubular arm (2) a bottom support (9) is found.

6. A constructive arrangement introduced in a wall support for television set and other appliances, according to claim 5, characterized in that the bottom support (9) has inside its lateral ends (9a), L-profiled supports (10), whose upper portions present semicircular profiles (10a).

7. A constructive arrangement introduced in a wall support for television set and other appliances, according to claim 6, characterized in that L-profiled supports (10) are fastened to the bottom support (9) through handles (11).

8. A constructive arrangement introduced in a wall support for television set and other appliances, according to claim 1, characterized in that at the back end of the horizontal tubular arm (2) a fixation base is fastened (12).

9. A constructive arrangement introduced in a wall support for television set and other appliances, according to claim 1, characterized in that a variant of the first model of support is provided, indicated by numerical reference (13) and which is characterized for having vertical supports (8′), which in turn have a disc (14) in each of their top ends, which incorporates a handle (15), in which a forked structure (16) is fastened, whose top ends (16a), composed by a sector (16a′) and a sector (16a″), are bent in right angle, turned inwards the support in question; plastic tips (16b) provide finishments to final portions of top ends (16a).

10. A constructive arrangement introduced in a wall support for television set and other appliances, according to claim 9, characterized in that blades (4a′) are assembled over the two tubular structures (4), whose front ends are bent upwards, in right angle, forming stretches (4a″), covered with a plastic cover (P).

11. A constructive arrangement introduced in a wall support for television set and other appliances, according to claim 9, characterized in that said variant has a protection cover (12″), which covers the fixation base (12′).
